(19) United States
(12) Patent Application Publication
(10) Pub. No.: US 2008/0195920 A1
(43) Pub. Date: Aug. 14, 2008

(54) SELF-TEST STRUCTURE AND METHOD OF TESTING A DIGITAL INTERFACE

(75) Inventors: Lawrence B. Luce, Sun Lakes, AZ (US); Paul Kelleher, Cork (IE); Diarmuid McSwiney, Ballincollig (IE)

Correspondence Address: MESCHKOW & GRESHAM, P.L.C., 5727 NORTH SEVENTH STREET, SUITE 409, PHOENIX, AZ, 85014, US

(73) Assignee: FREESCALE SEMICONDUCTOR, INC., Austin, TX (US)

(21) Appl. No.: 11/674,478

(22) Filed: Feb. 13, 2007

(51) Int. Cl. G06F 11/00; H04B 17/00

(52) U.S. Cl. 714/798; 375/221; 714/E11.067

(57) ABSTRACT

A digital interface (22) includes a self-test structure (56). The structure (56) includes a transmit section (52) and a receive section (36) having a correlator (68). A method (114) of testing the interface (22) entails coupling the receive section (36) with the transmit section (52) and communicating a test data structure (86) from the transmit section (52) to the receive section (36) at a high data rate. The test data structure (86) includes a pre-defined sync pattern (88), a header (90), and a payload (92). The receive section (36) detects the sync pattern (88) and performs time frame synchronization (148) at the correlator (68). When synchronization (148) is successful, the receive section (36) decodes (154, 162) the header (90) and the payload (92). If time frame synchronization (148) and decoding (154, 162) are successful, a validation indicator (100) is output for external observation at a low data rate.

### TECHNICAL FIELD OF THE INVENTION

The present invention relates generally to the field of digital communications. More specifically, the present invention relates to the testing of a radio frequency digital interface.

### BACKGROUND OF THE INVENTION

Third generation technology, referred to as 3G, is used in the context of mobile communications technology, with analog cellular being considered first generation, and digital personal communications service (PCS) being considered second generation. Key features offered by third generation (3G) mobile technologies are the momentous capacity and broadband capabilities to support greater numbers of voice and data customers, a high degree of commonality of design worldwide, compatibility of services, use of small pocket terminals with worldwide roaming capability, Internet and other multimedia applications, and a wide range of services and terminals. Some services associated with 3G provide the ability to transfer simultaneously both voice data (a telephone call) and non-voice data (such as downloading information, video telephony, exchanging email, and instant messaging).

A transceiver is an indispensable component for the realization of such a high-speed, high-capacity communication system. A transceiver is a two-way radio system that includes both a transmitter and a receiver for the exchange of information, such as voice, data, and the like. The digital interfaces for transceiver and wireless local area network (WLAN) devices are getting faster in order to meet the needs of the evolving communications technologies, such as 3G. For example, a radio frequency (RF) digital interface with 3G capability, such as the “DigRF 3G” RF Digital Interface Standard, can support circuit and packet data at high bit rates in excess of three hundred Megabits per second.

As dependence on wireless communication systems continues to increase and the systems continue to evolve, the need for reliability commensurately increases. Testing is a challenge in the implementation of a transceiver and its non-clocked digital interface built on a semiconductor chip. Such testing poses challenges in terms of costs and accuracy. For example, automated test equipment for testing a digital interface of a transceiver exists that is capable of handling a data signal transmitted or received at a high data rate, such as 312 Mbps. Such automated test equipment with RF capabilities and operable with high data rate digital data signals is expensive, resulting in undesirably high costs for conducting the testing. Other significantly less costly automated test equipment exists that can perform low data rate function tests. However, running low data rate function tests is undesirable because an operation performed at a higher data rate cannot be confirmed in a low data rate function test. Accordingly, whether a digital interface formed on a semiconductor chip has been produced without manufacturing defects cannot be confirmed. Thus, a need exists for a method and system to accurately and cost effectively test the functionality of a non-clocked digital interface.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a system in which a digital interface may be implemented;

FIG. 2 shows a block diagram of a test configuration for the digital interface of the system of FIG. 1;

FIG. 3 shows a flowchart of a digital interface test process for testing the functionality of the digital interface;

FIG. 4 shows a flowchart of a test configuration subprocess of the digital interface test process;

FIG. 5 shows a loopback test subprocess of the digital interface test process; and

FIG. 6 shows a chart of test signals produced during the execution of the loopback test subprocess of FIG. 5.

### DETAILED DESCRIPTION

One embodiment entails a built-in self-test (BIST) structure for a digital interface and a method for testing the digital interface. The digital interface is a non-clocked interface that includes a high speed line driver, a line receiver, and a high speed correlator. In order to achieve a high accuracy functional test, the BIST structure allows the testing of those functional blocks, i.e., the line driver, line receiver, and correlator, at their full data rate with internally generated and error-compared signals. The results of the testing are written to or read out of slow memory so that only slow data rate digital data is required from the automated test equipment. As such, the embodiments disclosed enable full data rate testing using less costly lower data rate automated test equipment. The disclosed embodiment is discussed in connection with a non-clocked radio frequency (RF) digital interface. However, the embodiment applies equivalently to any non-clocked digital interface.

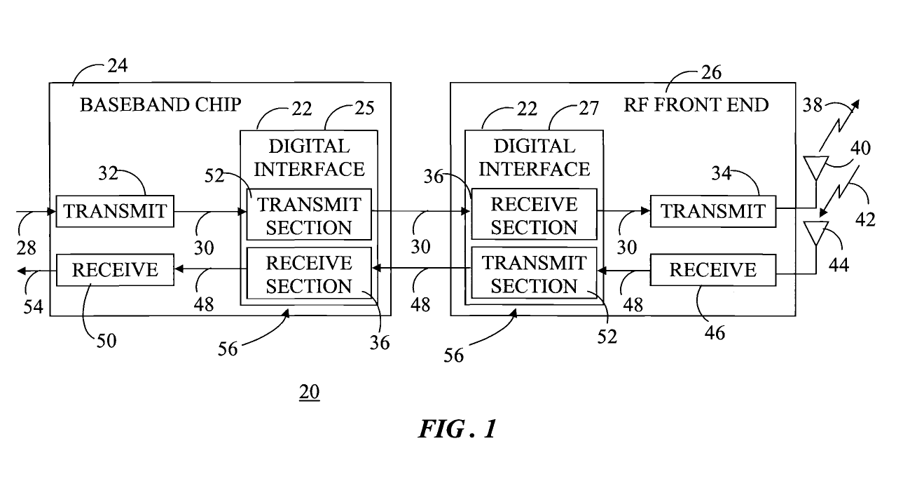

FIG. 1 shows a block diagram of a system 20 in which a digital interface 22 may be implemented. System 20 may be a transceiver configured for third generation (3G) communication capability. System 20 includes a baseband chip 24 and a radio frequency (RF) front end chip 26. Digital interface 22 is interposed between baseband chip 24 and RF front end chip 26. More specifically, each of baseband chip 24 and RF front end chip 26 includes its own embedded digital interface 22. A first digital interface 25 is embedded within baseband chip 24 and a second digital interface 27 is embedded within RF front end chip 26 function to facilitate communication between baseband chip 24 and RF front end chip 26. Baseband chip 24 and RF front end chip 26 may be independently produced and their corresponding first and second digital interfaces 25 and 27, respectively, may be incorporated into each during manufacturing.

The reference numeral “25” is used herein to distinguish the one of digital interfaces 22 embedded within baseband chip 24, and the reference numeral “27” is used herein to distinguish the one of digital interfaces 22 embedded within RF front end chip 26. However, it should be understood that first and second digital interfaces 25 and 27 are essentially identical. Accordingly, the reference numeral “22” will be used below when referring to either of first and second digital interfaces 25 and 27, respectively. In addition, the reference numerals “25” and “27” will be used below when identifying a particular digital interface 22 embedded within either of baseband chip 24 and RF front end chip 26.

For signal transmission, a voice or data signal, represented by an arrow 28, is received from upstream circuitry (not shown) of system 20. Baseband chip 24 converts voice or data signal 28 to a baseband analog or digital signal 30 that is communicated from a transmit portion 32 of baseband chip 24 to a transmit section 52 of first digital interface 25. Baseband signal 30 is then communicated from transmit section 52 of first digital interface 25 toward a transmit portion 34 of RF front end chip 26 via a receive section 36 of second digital interface 27. Digital interface 22, embodied as first and second digital interfaces 25 and 27, is an asynchronous serial interface with differential signaling over which baseband chip 24 and RF front end chip 26 communicate the successful transfer of control and data signals. Digital interface 22 manages operating mode controls, synchronization signals, and baseband signal 30 communicated from baseband chip 24 to RF front end chip 26. Transmit portion 34 of RF front end chip 26 converts baseband signal 30 to an outgoing RF signal 38 that can be applied to an antenna 40 for transmission.

For signal reception, an incoming RF signal 42 is received at an antenna 44 of system 20. Although two antennas are shown, those skilled in the art will recognize that antenna 40 and antenna 44 may be the same component that is configured to both transmit and receive signals. Incoming signal 42 is input into a receive portion 46 of RF front end 26 where it is converted into a baseband analog or digital signal 48 and communicated to transmit section 52 of second digital interface 27. Baseband signal 48 is then communicated from transmit section 52 of second digital interface 27 toward a receive portion 50 of baseband chip 24 via receive section 36 of first digital interface 25. Digital interface 22, embodied as first and second digital interfaces 25 and 27, manages operating mode controls, synchronization signals, and baseband signal 48 communicated from RF front end chip 26 to baseband chip 24. At receive portion 50 of baseband chip 24, baseband signal 48 is converted to a voice or data signal, represented by an arrow 54.

As will be discussed in greater detail below, receive section 36 and transmit section 52 of digital interface 22 together include a built-in self-test (BIST) structure 56 that allows for functional testing of digital interface 22 at a full data rate internal to digital interface 22, which is necessary for a reliable test of digital interface 22. However, the test interface to digital interface 22 runs at a data rate that is slower than the full data rate of digital interface 22, thus allowing the use of less costly slower data rate automated test equipment. Although the present invention is discussed in the context of the DigRF 3G digital interface which defines a full data rate for digital interface 22 of 312 Mbps, such is not a limitation. Rather, other embodiments may be utilized with devices having less than or greater than 312 Mbps data rates for which cost savings can be achieved for functional testing through the use of slower data rate automated test equipment in lieu of high data rate automated test equipment.

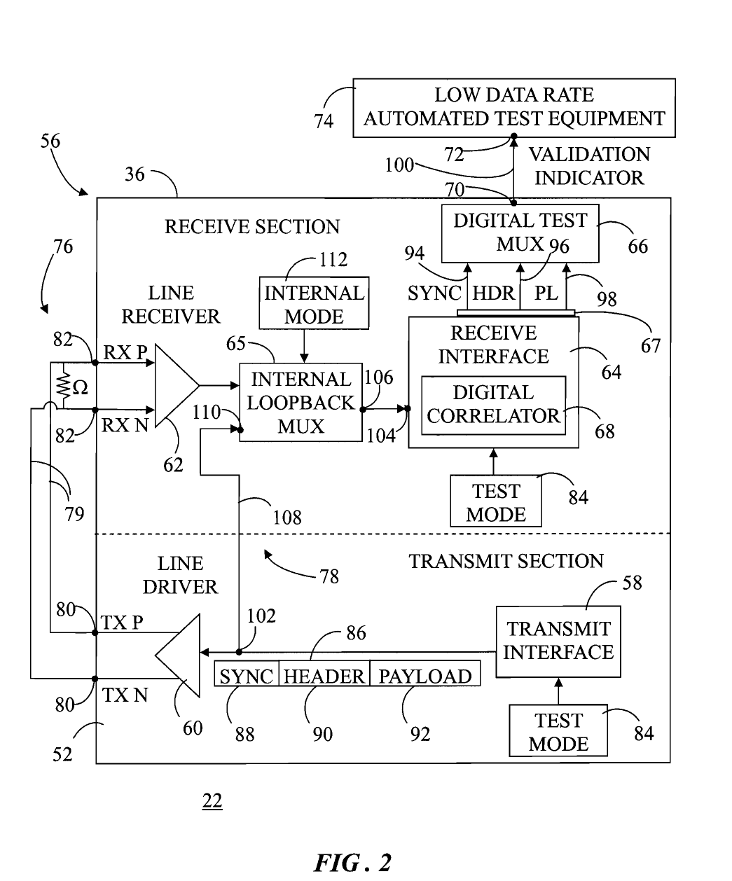

FIG. 2 shows a block diagram of a test configuration for digital interface 22 of system 20 (FIG. 1). Components of receive section 36 and transmit section 52 that make up BIST structure 56 of digital interface 22 are shown in FIG. 2. However, it should be understood that digital interface 22 can include various additional components that are not shown herein for clarity of illustration.

Transmit section 52 of digital interface 22 includes an output controller, referred to herein as a transmit interface portion 58, in communication with a line driver 60. Receive section 36 includes a line receiver 62 in communication with an input controller, referred to herein as a receive interface portion 64, via an internal loopback multiplexer 65. Various embodiments may enable either an external mode loopback test (discussed below), an internal mode loopback test (discussed below), or both external mode and internal mode loopback tests. Accordingly, multiplexer 65 is only needed if both external mode and internal mode loopback test capability is to be provided.

A digital test multiplexer 66 is in communication with an output 67 of receive interface portion 64, and a digital correlator 68 is located within receive interface portion 64. In addition, digital test multiplexer 66 has an output 70 coupled with an input 72 of a low data rate automated test equipment 74. As mentioned above, transmit interface portion 58, line driver 60, line receiver 62, receive interface portion 64, and digital correlator 68 may be configured to operate at a high data rate. For example, these components may operate at a full data rate of 312 Mbps. The term “low data rate” associated with automated test equipment 74 refers to known testers whose capabilities are predominately mixed signal with maximum data rates that are lower than the full data rate for digital interface 22.

Digital interface 22 is a non-clocked digital interface. In normal operation, external signals are received at line receiver 62. For example, in the configuration of system 20 (FIG. 1), baseband signal 30 (FIG. 1) is communicated from baseband chip 24 and is received at line receiver 62 of second digital interface 27 (FIG. 1) of RF front end 26 (FIG. 1). Digital correlator 68 performs time alignment with the incoming baseband signal 30 and detects a data structure within baseband signal 30. Baseband signal 30 is subsequently communicated to transmit portion 34 (FIG. 1) of RF front end chip 26 (FIG. 1), as discussed above. Similarly, in the configuration of system 20, baseband signal 48 (FIG. 1) is communicated from RF front end chip 26 and is received at line receiver 62 of first digital interface 25 (FIG. 1) of baseband chip 24. Additionally, in normal operation, signals are output from line driver 60. For example, in the configuration of system 20 (FIG. 1), baseband signal 30 is output from line driver 60 of transmit section 52 of first digital interface 25. Likewise, baseband signal 48 is output from line driver 60 of transmit section 52 of second digital interface 25.

BIST structure 56 of digital interface 22 is configured for loopback testing. Loopback testing generally refers to a diagnostic procedure in which a signal is transmitted and returned to the sending device. The returned signal can be compared with the transmitted signal in order to evaluate the integrity of the equipment. BIST structure 56 enables an external mode loopback test 76 and an internal mode loopback test 78. External mode loopback test 76 is performed to test transmit interface portion 58, line driver 60, line receiver 62, and receive interface portion 64 with digital correlator 68 by temporarily interconnecting an output of line driver 60 with an input of line receiver 62. Internal mode loopback test 78 is performed to test transmit interface portion 58 and receive interface portion 64 with digital correlator 68 by temporarily interconnecting an output from transmit interface portion 58 with an input to receive interface portion 64, thus bypassing line driver 60 and line receiver 62.

To configure digital interface 22 for external mode loopback test 76, external lines 79 are interconnected between driver outputs 80 of line driver 60 and receiver inputs 82 of line receiver 62. Thus, first lines 79 are located external to digital interface 22. External mode loopback test 76 is initiated when a test mode signal 84 is asserted at each of transmit interface portion 58 and receive interface portion 64. Test mode signal 84 may be asserted in response to an external stimulus from, for example, automated test equipment 74. Once test mode signal 84 is asserted, transmit interface portion 58 sends a test data pattern, i.e., a test data structure 86, to line driver 60. Line driver 60 outputs test data structure 86, which is subsequently received at line receiver 62 via first lines 79. Line receiver 62 communicates test data structure 86 to receive interface portion 64 where it is detected and decoded (discussed below).

In one embodiment, test data structure 86 includes a synchronization pattern 88, a header 90, and a payload 92. If test data structure 86 is successfully detected and decoded, receive interface portion 64 outputs one or more validation indicator signals, in this case, a synchronization valid signal (SYNC) 94, a header valid signal (HDR) 96, and a payload valid signal (PL) 98, to digital test multiplexer 66. Digital test multiplexer 66 can subsequently output signals 94, 96, and 98 as at least one validation indicator 100, for example, a static pass flag, to low data rate automated test equipment 74 at a low data rate relative to the full operating data rate for digital interface 22. For example, the full data rate for digital interface 22 may be 312 Mbps, while validation indicator 100 may be output at a significantly lower data rate, for example, less than 80 Mbps. In one embodiment, validation indicator 100 may signal the unsuccessful detection and decoding of test data structure 86 through the absence of one or all of synchronization valid signal 94, header valid signal 96, and payload valid signal 98. However in alternative embodiments, validation indicator 100 may signal the unsuccessful detection and decoding of test data structure 86 through error signals, for example, a static fail flag, generated and output by receive interface 64. In yet another alternative embodiment, digital test multiplexer 66 may be bypassed or even absent, and any or all of synchronization valid signal 94, header valid signal 96, and payload valid signal 98 may be output directly to low data rate automated test equipment 74.

A transmit interface output 102 is interposed between transmit interface portion 58 and an input of line driver 60, and a receive interface input 104 is interposed between receive interface portion 64 and line receiver 62. More particularly, receive interface input 104 is positioned between an output 106 of internal loopback multiplexer 65 and receive interface portion 64. BIST structure 56 further includes a second line 108, for example, a conductive trace, for selective interconnection of transmit interface output 102 to receive interface input 104 via internal loopback multiplexer 65. That is, second line 108 interconnects transmit interface output 102 with an input 110 of internal loopback multiplexer 65. To configure digital interface 22 for internal mode loopback test 78, an internal mode signal 112 is asserted at internal loopback multiplexer 65 and test mode signal 84 is asserted. Digital interface 22 is only placed in internal mode loopback test 78 when both internal mode signal 112 and test mode signal 84 are asserted. Thus, internal loopback multiplexer 65 acts as a switch to select between, for example, a default mode, i.e., external mode loopback test 76 when external lines 79 are connected, and an alternative mode, i.e., internal mode loopback test 78 when external lines 79 are not connected. Once digital interface 22 is placed in internal mode loopback test 78, the same test procedure briefly discussed above is executed.

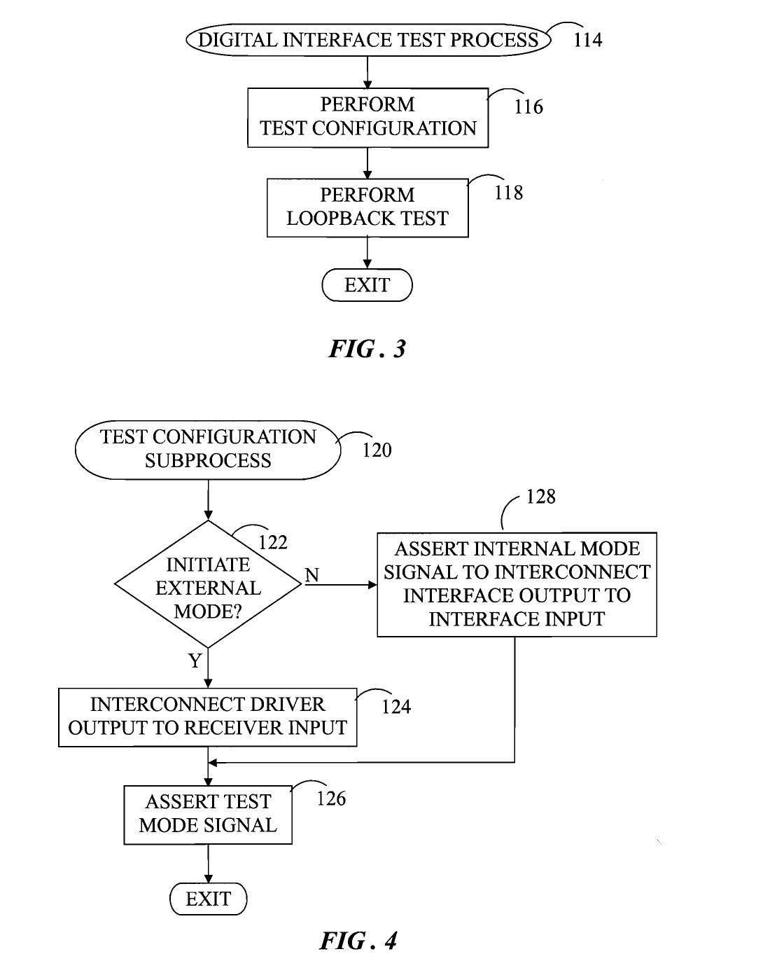

FIG. 3 shows a flowchart of a digital interface test process 114 for testing the functionality of the digital interface 22 (FIG. 2). The following methodology will be discussed in connection with testing a semiconductor chip of a single digital interface 22. However, the following methodology applies equivalently to multi-site testing so as to attain a high test throughput. One exemplary multi-site testing configuration is a quad-site application in which four semiconductor chips with digital interface 22 are simultaneously tested. The tasks of digital interface test process 114 may be executed through operator intervention and/or signaling from low data rate automated test equipment 74, and may be implemented in digital interface 22 as software, hardware, or some combination thereof. In addition, digital interface test process 114 may be implemented to test the functionality of digital interface 22, embodied as first digital interface 25 (FIG. 1) embedded in baseband chip 24, and/or to test the functionality of digital interface 22, embodied as second digital interface 27 (FIG. 1) embedded in RF front end 26 (FIG. 1)

Digital interface test process 114 begins with a task 116. At task 116, a test configuration subprocess is performed to establish one of external mode loopback test 76 (FIG. 2) or internal mode loopback test 78 (FIG. 2). The test configuration subprocess will be discussed in detail in connection with FIG. 4.

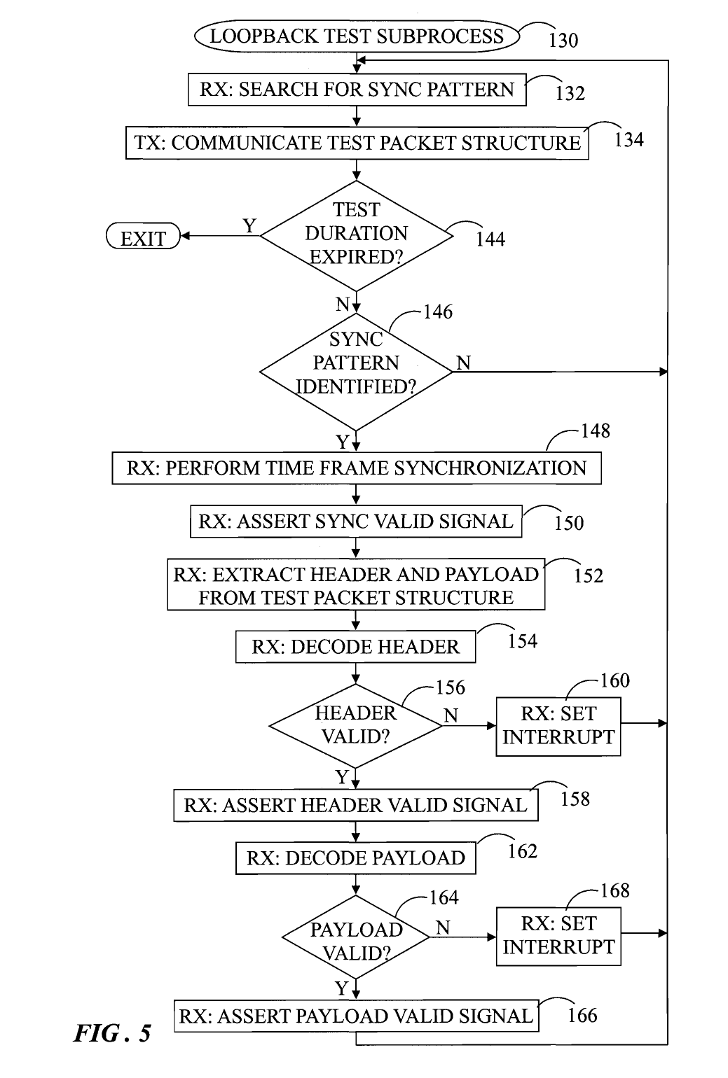

Following task 116, a task 118 is executed. At task 118, a loopback test subprocess is performed to test the functionality of semiconductor chips with digital interface 22. The loopback test subprocess will be discussed in detail in connection with FIG. 5. Following task 118, digital interface test process 114 exits. Of course, in a production line application, digital interface test process is repeated for all digital interface chips 22 being manufactured.

FIG. 4 shows a flowchart of a test configuration subprocess 120 of the digital interface test process 114 (FIG. 3). Test configuration subprocess 120 may be executed through operator intervention, signaling from low data rate automated test equipment 74 (FIG. 2), or some combination thereof.

Test configuration subprocess 120 begins with a query task 122. At query task 122, a determination is made as to whether external mode loopback test 76 (FIG. 2) is to be performed. When external mode loopback test 76 is to be performed, subprocess 120 proceeds to a task 124.

At task 124, driver outputs 80 (FIG. 2) are interconnected with receiver inputs 82 using externally positioned transmission lines 76 (FIG. 2). Following task 124, process control proceeds to a task 126. At task 126, test mode signal 84 (FIG. 2) is asserted.

However, at query task 122, when a determination is made that external mode loopback test 76 is not to be performed, i.e., internal mode loopback test 78 (FIG. 2) is to be performed, process control proceeds to a task 128. At task 128, internal mode signal 112 is asserted at internal loopback multiplexer 65 to enable interconnection of transmit interface output 102 (FIG. 2) with receive interface input 104 via second line 108 and internal loopback multiplexer 65 (FIG. 2).

Following task 128, process control proceeds to task 126 where test mode signal 84 is asserted. Following task 126, test configuration subprocess 120 exits with either external mode loopback test 76 or internal mode loopback test 78 enabled.

FIG. 5 shows a loopback test subprocess 130 of the digital interface test process 114 (FIG. 3). Loopback test subprocess 130 is initiated by BIST structure 56 (FIG. 2) of digital interface 22 (FIG. 2) in response to assertion of test mode signal 84 (FIG. 2) in test configuration subprocess 120 (FIG. 4). Loopback test subprocess 130 may be implemented in digital interface 22 as software, hardware, or a combination of software and hardware. Within the flowchart of FIG. 5, the term “RX:” refers to an operation undertaken by receive section 36 (FIG. 2) of digital interface 22 and the term “TX:” refers to an operation undertaken by transmit section 52 of digital interface 22.

Loopback test subprocess 130 begins with a task 132. At task 132, receive interface portion 64 (FIG. 2) searches for sync pattern 88 (FIG. 2) in any incoming data.

A task 134 is performed in connection with task 132. At task 134, transmit interface portion 58 outputs test data structure 86 (FIG. 2). Although tasks 132 and 134 are illustrated as serial operations, it should be understood that they are likely to be performed concurrently in response to assertion of test mode signal 84 (FIG. 2).

In an exemplary scenario, once test mode signal 84 is asserted, transmit interface portion 58 will send to line driver 60 (FIG. 2) a fixed frame repeated periodically. This fixed frame is test data structure 86 (FIG. 2). Transmit interface portion 58 may send test data structure 86 following a time interval, such as 0.769 microseconds, and will repeat output of test data structure 86 every 0.769 microseconds for an entire test duration. In one embodiment, the transmitted bitstream, i.e., test data structure 86, is a packetized, fixed frame that is periodically transmitted. However, in alternate embodiments of the present invention, the bitstream i.e., the test data structure, may be input by low data rate automated test equipment 74 (FIG. 2), in which case the test data structure could be fixed or varying, single shot or periodic, and packetized or not. That is, the present invention applies to any non-clocked bitstream interface that requires correlation.

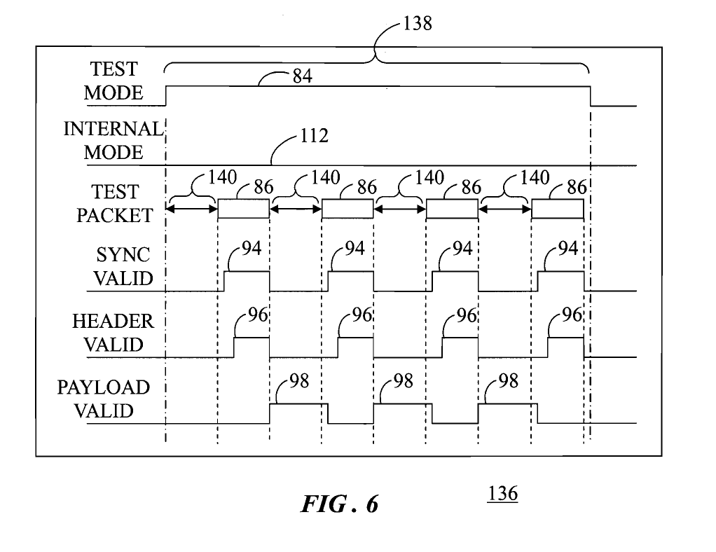

Referring to FIG. 6 in connection with task 134 of loopback test subprocess 130, FIG. 6 shows a chart 136 of test signals produced during the execution of loopback test subprocess 130. Chart 136 shows that test mode signal 84 has been asserted and will remain asserted for a test duration 138. However, in this exemplary scenario, internal mode signal 112 was not asserted during the execution of test configuration subprocess 120. Therefore, the current loopback test subprocess 130 is being run as external mode loopback test 76 (FIG. 2). As shown, transmit interface portion 58 (FIG. 2) sends test data structure 86 following a test repetition delay interval 140. Test data structure 86 is repeatedly sent separated by a test repetition delay interval 140. In an alternate embodiment, the test may be a single shot event. Consequently, in such an embodiment, test repetition delay interval 140 would not be required.

Referring back to FIG. 5, in response to the communication of test data structure 134 from transmit interface portion 58 at task 134, process control proceeds to a query task 144. At query task 144, a determination is made as to whether test duration 138 (FIG. 6) has expired. When test duration 138 has expired, loopback test subprocess 130 exits. However, when test duration 138 has not expired process control proceeds to a query task 146.

At query task 146, a determination is made as to whether sync pattern 88 is identified in any incoming signal. Receive interface portion 64 searches for sync pattern 88 (FIG. 2) which is at the start of each test data structure 86 (FIG. 2). Sync pattern 88 may be, for example, a sixteen bit known pattern that is used to detect test data structure 86. When sync pattern 88 is not identified, subprocess 130 loops back to task 132 to continue monitoring for sync pattern 88 and to continue communicating test data structure 86 for test duration 138 (FIG. 6). In one embodiment, if sync pattern 88 is not identified throughout an entire test duration 138, an interrupt may be set to indicate as such. This interrupt may be communicated to automated test equipment 74 as validation indicator 100 (FIG. 2) to indicate an unsuccessful test. However, when sync pattern is identified at query task 146, process control proceeds to a task 148.

At task 148, time frame synchronization is performed. More specifically, digital correlator 68 (FIG. 2) identifies the best clock phase to use to sample the incoming data. For example, correlator 68 identifies which of the eight or four phases are valid for sampling the incoming test data structure 86. Task 148 chooses which clock phase to use if there is more than one that satisfies the cross-correlation threshold requirement.

In response to task 148, a task 150 is performed. Once the clock phase is selected during time frame synchronization task 148, synchronization valid signal 94 (FIG. 3) is asserted. Signal 94 indicates that sync pattern 88 was detected and synchronization has been completed successfully. That is, test data structure 86 has been detected correctly. Once the correlation is finished and the clock phase is selected, then synchronization is complete, and the correct clock phase to sample test data structure 86 can be used.

Referring to FIG. 6 in connection with task 150, chart 136 shows synchronization valid signal 94 being asserted every time frame synchronization occurs. As shown, synchronization valid signal 94 remains high for the duration of the bits of header 90 (FIG. 2) and payload 92 (FIG. 2) of test data structure 86. In one embodiment, once it is asserted, synchronization valid signal 94 remains valid until the end of test data structure, i.e., the frame. However, it should be understood that in other embodiments, synchronization valid signal 94 can remain valid until the start of the next test data structure 86, i.e., the next frame.

No sync valid signal 94 will be asserted if sync pattern 88 is not identified at query task 146. When sync valid signal 94 is not observed or is not observed after a specific amount of time, this indicates that digital interface 22 (FIG. 2) is not operating correctly. For example, in external mode loopback test 76, either line driver 60 is not manipulating test data structure 86 correctly for transmission or line receiver 62 (FIG. 2) cannot detect and decode test data structure 86 correctly. This may be due to incorrect speed settings, incorrect encoding and decoding, clock issues, bad connections between line driver 60 and line receiver 62 and so forth.

With reference back to FIG. 5, following the assertion of synchronization valid signal 94 at task 150, process control proceeds to a task 152. At task 152, receive interface portion 64 (FIG. 2) extracts header 90 (FIG. 2) and payload 92 (FIG. 2) from data structure 86, also known as the frame.

In response to task 152, a task 154 is performed. At task 154, header 90 is decoded at receive interface portion 64. Each of header 90 and payload 92 include pre-defined codes that are detectable upon successful decoding. For example, header 90 may be an eight bit instruction that indicates what to do with payload 92, such as decode and perform some action, store payload 92, and so forth. In an alternate embodiment, header 90 may be an eight bit instruction to enter a loopback test mode, and as such, header 90 would embody test mode assertion signal 84.

A query task 156 is performed in connection with task 154. At query task 156, a determination is made as to whether the decoded header 90 is valid. When header 90 is valid, subprocess 130 continues with a task 158. At task 158, receive interface portion 64 (FIG. 2) asserts header valid signal 96 (FIG. 2).

Referring to FIG. 6 in connection with task 158, chart 136 shows header valid signal 96 being asserted every time a valid header 90 is successfully decoded. As shown, header valid signal 96 remains high for the duration of the bits of payload 92 (FIG. 2) of test data structure 86. In one embodiment, once it is asserted, header valid signal 96 remains valid until the end of test data structure, i.e., the frame. However, it should be understood that in other embodiments, header valid signal 94 can remain valid until the start of the next test data structure 86, i.e., the next frame.

With reference back to FIG. 5, when query task 156 determines that the decoded header 90 is not valid, subprocess 130 proceeds to a task 160. At task 160, an interrupt is set by receive interface 64 so that the remainder of test data structure 86 will subsequently be ignored by receive interface 64. Following task 160, program control loops back to task 132 to again monitor for sync pattern 88. If header valid signal 96 is not observed at low data rate automated test equipment 74 after a specific amount of time, this indicates that digital interface 22 (FIG. 2) may not be operating correctly.

Following the assertion of header valid signal 96 at task 158, loopback test subprocess 130 continues with a task 162. At task 162, payload 92 (FIG. 2) may be decoded by receive interface portion 64. The size of payload 92 may be any of a number of pre-defined bits, such as 8, 32, 64, 96, 128, 256, 512, or a user defined payload size. In accordance with the loopback test subprocess 130, payload 92 contains pre-defined data pertinent to loopback testing. This pre-defined data may be “hard-wired” into digital interface 22 as hardware or firmware, or it may be loaded into digital interface 22 by low data rate automated test equipment 74 as part of the test process. One embodiment contemplates the use of pre-defined data for determining valid decoding with sufficient reliability. However, alternate embodiments may include non-predefined data with parity, a cyclic redundancy check (CRC), or restricting payload 92 to one of a finite number of acceptable bit sequences such as Gold codes, Walsh codes, and the like.

In response to task 162, a query task 164 is performed. At query task 164, a determination is made as to whether payload 92 is valid. When payload 92 is valid, subprocess 130 continues with a task 166. At task 166, receive interface portion 64 (FIG. 2) asserts payload valid signal 98 (FIG. 2).

Referring to FIG. 6 in connection with task 164, chart 136 shows payload valid signal 98 being asserted every time a valid payload 92 is successfully decoded. As shown, payload valid signal 98 remains high following test data structure until assertion of the next synchronization valid signal 94.

Referring back to FIG. 5, following the assertion of payload valid signal 98, process control loops back to task 132 to continue monitoring for sync pattern 88 (FIG. 2) until test duration 138 (FIG. 6) has expired.

However, subprocess 130 proceeds to a task 168 when a determination is made at query task 164 that the decoded payload 92 is not valid. At task 168, an interrupt is set by receive interface 64 so that the remainder of the invalid payload 92 will subsequently be ignored by receive interface 64. Following task 168, program control loops back to task 132 to again monitor for sync pattern 88 until test duration 138 (FIG. 6) has expired. If payload valid signal 98 is not observed, this indicates that digital interface 22 (FIG. 2) may not be building or detecting data structure 86 correctly. An absence of any or all of synchronization valid signal 94, header valid signal 96, and payload valid signal 98, can result in digital interface being rejected because it has malfunctioned.

An embodiment described herein comprises a method of testing a non-clocked radio frequency digital interface using a loopback test technique. Another embodiment comprises a radio frequency digital interface that includes a built-in self-test structure. The built-in self-test structure includes a transmit section and a receive section having a correlator. The transmit section and receive sections are interconnected either externally or internally and a test data structure is communicated from the transmit section to the receive section in accordance with the loopback test technique. Capability is provided for testing the high data rate elements of the non-clocked digital interface at full data rate, with the resulting data being downloaded or read out of the digital interface to significantly lower data rate automated test equipment. That is, the built-in self-test structure tests those functional blocks at speed with internally generated and error-compared signals so that only slow-speed digital capability is required from the automated test equipment. Consequently, accurate testing of the digital interface chip can be achieved at significant cost savings by utilizing lower cost, lower data rate automated test equipment.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A method of testing a digital interface having a transmit section and a receive section, said receive section including a correlator, and said method comprising:
coupling an output of said transmit section with an input of said receive section;
communicating a test data structure from said transmit section to said receive section;
detecting said test data structure at said correlator;
decoding said test data structure at said receive section; and
when said test data structure is successfully decoded, producing at least one validation indicator for observation external to said digital interface, said validation indicator indicating that said digital interface functions properly.

2. A method as claimed in claim 1 wherein said transmit section includes a line driver, said output is a driver output of said line driver external to said digital interface, said receive section includes a line receiver, said input is a receiver input of said line receiver external to said digital interface, and said coupling operation comprises interconnecting said driver output with said receiver output.

3. A method as claimed in claim 1 wherein said transmit section includes a transmit interface portion in communication with a line driver, said receive section includes a receive interface portion in communication with a line receiver, said output is an interface output interposed between said transmit interface portion and said line driver, said input is an interface input interposed between said receive interface portion and said line receiver, and said coupling operation comprises interconnecting said interface output with said interface input.

4. A method as claimed in claim 1 wherein said test data structure includes a sync pattern, and said detecting operation comprises:
identifying said sync pattern in said test data structure; and
performing time frame synchronization at said correlator in response to identification of said sync pattern.

5. A method as claimed in claim 4 wherein when said time frame synchronization is successful, said producing operation comprises asserting a synchronization valid signal of said validation indicator.

6. A method as claimed in claim 4 wherein said test data structure includes a header, and:
when said time frame synchronization is successful, said decoding operation decodes said header from said test data structure; and
when said header is successfully decoded, said producing operation comprises asserting a header valid signal of said validation indicator.

7. A method as claimed in claim 4 wherein said test data structure includes a payload, and:
when said time frame synchronization is successful, said decoding operation decodes said payload from said test data structure; and
when said payload is successfully decoded, said producing operation comprises asserting a payload valid signal of said validation indicator.

8. A method as claimed in claim 1 further comprising:
performing said communicating, detecting, and decoding operations at a first data rate for said digital interface; and
outputting said at least one validation indicator from said receive section of said digital interface at a second data rate, said second data rate being lower than said first data rate.

9. A method as claimed in claim 1 further comprising rejecting said digital interface when said test data structure is unsuccessfully decoded.

10. A digital interface comprising:
a self-test structure, said self-test structure comprising:
a transmit section configured to communicate a test data structure, said test data structure including a sync pattern and a payload;
a receive section selectively coupled to said transmit section, said receive section including a correlator, and said receive section being configured to receive said test data structure, perform time frame synchronization at said correlator in response to identification of said sync pattern, decode said test data structure, and when said test data structure is successfully decoded, produce at least one validation indicator for observation external to said digital interface, said validation indicator indicating that said digital interface functions properly.

11. A digital interface as claimed in claim 10 wherein:
said transmit section comprises a transmit interface portion, a line driver in communication with said transmit interface portion, and an interface output interposed between said transmit interface portion and said line driver;
said receive section comprises a receive interface portion, a line receiver in communication with said receive interface portion, and an interface input interposed between said receive interface portion and said line receiver; and
a line selectively interconnecting said interface output with said interface input.

12. A digital interface as claimed in claim 11 further comprising a selector having a first input in selective communication with an output of said line receiver for receipt of said test data structure in an external mode test, a second input in selective communication with said line for receipt of said test data structure in an internal mode test, and having an output in communication with said interface input for transfer of said test data structure received at one of said first and second inputs to said receive interface portion.

13. A digital interface as claimed in claim 10 wherein said receive section comprises a validation output for interconnection with an external test equipment, said receive section conveying said at least one validation indicator to said external test equipment via said validation output.

14. A digital interface as claimed in claim 13 wherein:
said transmit section and said receive section are configured to operate at a first data rate for said digital interface; and
said receive section is configured to output said at least one validation indicator via said validation output at a second data rate, said second data rate being lower than said first data rate.

15. A digital interface as claimed in claim 13 wherein said digital interface is non-clocked.

16. A method of testing a digital interface having a transmit section and a receive section, said transmit section including a line driver, said receive section including a line receiver and a correlator, and said method comprising:
interconnecting a driver output of said line driver with a receiver input of said line receiver to enable an external test mode;
communicating a test data structure from said line driver of transmit section to said receive section via said line receiver, said test data structure including a sync pattern and a payload;
detecting said packet at said correlator, said detecting operation including identifying said sync pattern in said test data structure and performing time frame synchronization in response to identification of said sync pattern;
decoding said payload at said receive section following said time frame synchronization; and
when said test data structure is successfully decoded, producing at least one validation indicator for observation external to said digital interface, said producing operation asserting a payload valid signal of said validation indicator indicating a validity of said payload in said test data structure.

17. A method as claimed in claim 16 wherein said transmit section further includes a transmit interface portion in communication with said line driver, said receive section includes a receive interface portion in communication with said line receiver, an interface output is interposed between said transmit interface portion and said line driver, an interface input is interposed between said receive interface portion and said line receiver, and said method further comprises:
coupling said interface output with said interface input in lieu of said interconnecting operation to enable an internal test mode; and
performing said communicating, detecting, decoding, and producing operations with said internal test mode enabled.

18. A method as claimed in claim 16 further comprising asserting a synchronization valid signal of said validation indicator when said time frame synchronization is successful.

19. A method as claimed in claim 16 wherein:
said decoding operation further decodes a header of said test data structure; and
said producing operation asserts a header valid signal of said validation indicator when said header is successfully decoded.

20. A method as claimed in claim 16 further comprising:
performing said communicating, detecting, and decoding operations at a first data rate for said digital interface; and
outputting said at least one validation indicator from said receive section of said digital interface at a second data rate, said second data rate being lower than said first data rate.
